(19) United States
(12) Patent Application Publication
(10) Pub. No.: US 2018/0216659 A1
(43) Pub. Date: Aug. 2, 2018

(54) Spherical Ball Joint Assembly

(71) Applicant: David John Hoppert, Woodburn, OR (US)

(72) Inventor: David John Hoppert, Woodburn, OR (US)

(21) Appl. No.: 15/419,491

(22) Filed: Jan. 30, 2017

(51) Int. Cl. F16C 11/06

(52) U.S. Cl. CPC F16C 11/0614; F16C 11/0666

(57) ABSTRACT

An improved mechanical joint that remains together under combined vertical, angular and torsional loads, provides vibrational isolation to the stresses experienced and transmitted by any connected members, offers increased angular movement at the joint, and will allow torsional movement. It has its primary use in the automotive industry to connect the control arms to the steering knuckles of an automobile, although they have a plethora of other mechanical applications such as in the movable joints of dolls.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to mechanical joints, and more particularly to vibrational isolating spherical bearing technology as may be commonly found in vehicular applications such as a front arm, rod arm or a trailing link suspension component.

### BACKGROUND

There are several places on a vehicle where a mechanical joint on a vertically moving element (such as a bracket) is necessary. This is especially so in suspension applications. These require vibrational isolation, and commonly employ a rubber isolation spacer bonded and fitted between two adjacent steel or metal components to accomplish this. These bonded rubber spacers are intended for elastic compression in the direction of the movement of the joint.

Generally, the rubber isolation spacers directly contact and are replaceably affixed in a mounting bracket. They have a central through bore that is sized for frictional engagement with a rod or bolt. They commonly have adaptor bushings to accommodate rods or bolts of varying diameters. The spacer is retained in its mounting bracket by physical barriers placed on each side, usually it is part of the suspension member. The rod or bolt is connected to a pivotable suspension member that travels vertically. In this arrangement, the suspension member undergos primarily, vertical travel at its distal end and rotational motion about the centerline of the rod/bolt at its proximal end. However, many such joints experience smaller components of horizontal and/or torsional stress loads as the vehicle is subjected to various angular and rotational forces. These forces are transmitted to the rubber isolation spacer. While the spacer can withstand very limited stress loads at angles to the direction of motion of the joint, repeated and larger secondary stresses can lead to premature failures (such as tears) in the spacers of the joints.

Henceforth, an improved mechanical joint that 1) remains together under combined vertical, angular and torsional loads, 2) provides vibrational isolation to the stresses experienced, 3) offers increased angular movement at the joint, and 4) allows torsional movement, would fulfill a long felt need in many areas of mechanical equipment, specifically in the automotive industry. This new invention utilizes and combines known and new technologies in a unique and novel configuration to overcome the aforementioned problems and accomplish this.

### BRIEF SUMMARY

In accordance with various embodiments, a one piece, rubber isolated spherical ball joint assembly is provided, capable of offering an additional angular range of motion.

In one aspect, a unitary vibrational mount with the ability to dampen vertical stress loads while accommodating limited torsional and horizontal stress loads without failure is provided.

In another aspect, a rubber isolated spherical ball joint assembly fabricated as a single (unitary) component is provided that can offer additional vibrational isolation.

In yet another aspect, an improved spherical ball joint assembly is provided that has a bonded natural rubber mount between the joint housing and the spherical ball race.

In yet a further aspect, a vibrational and shock isolated spherical ball joint assembly that has replaceable polymer isolation bushings is provided.

Various modifications and additions can be made to the embodiment discussed without departing from the scope of the invention. For example, while the embodiment described above refer to particular features, the scope of this invention also includes embodiments having different combination of features and embodiments that do not include all of the above described features. The field of use is not intended to be limited to vehicles, but finds its way to a plethora of mechanical applications in a host of fields including, but not limited to marine, aviation, machine tools and the like.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is an assembly view of the first embodiment ball joint assembly with a threaded shank extending normally from the joint body;

FIG. 2 is a side view of the first embodiment ball joint assembly with an adaptor bushing frictionally affixed therein;

FIG. 3 is a cross sectional view of the first embodiment ball joint assembly taken through the axis designated GG in FIG. 2,

FIG. 4 is a perspective view of first embodiment ball joint assembly with an adaptor bushing frictionally affixed thereto;

FIG. 5 is an assembly view of the first embodiment ball joint assembly

FIG. 6 is an assembly view of the second embodiment ball joint assembly;

FIG. 7 is a front view of the second embodiment ball joint assembly

FIG. 8 is a cross sectional view of the second embodiment ball joint assembly taken through the axis designated as AA in FIG. 7;

FIG. 9 is a rear view of the second embodiment ball joint assembly;

FIG. 10 is a side perspective cross section of the second embodiment ball joint assembly with an adaptor busing frictionally affixed therein;

FIG. 11 is an assembly view of the third embodiment ball joint assembly with an optional cylindrical busing member;

FIG. 12 is a front view of the third embodiment ball joint assembly;

FIG. 13 is a cross sectional view of the third embodiment ball joint assembly taken through the axis designated JJ in FIG. 12;

FIG. 14 is a rear view of the third embodiment ball joint;

FIG. 15 is a front view of the first embodiment ball joint with the ball rotated axially to its operational extent within its cage,

FIG. 16 is a cross sectional view of the first embodiment ball joint of FIG. 15 showing the normal angular extents line taken through the line LL; and

FIG. 17 is an assembly view of the second embodiment ball joint with a cylindrical ball joint body.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

As used herein, the term “ball joint” refers to a spherical bearing commonly used to connect the control arms to the steering knuckles of an automobile, although they have a plethora of other mechanical applications. (Most commonly these can be found in the movable joints of dolls.) It is used to allow simultaneous free motion in two planes. As such, they commonly function as the pivot point between the wheels and the suspension of a vehicle.

As used herein, the term “bonded” refers to rubber adhered to metal (generally sandblasted metal). Commonly this is accomplished by a process known as vulcanizer curing where a rubber lined metal article is put in a live steam vulcanizer and cured under pressure. This techniques yields the strongest rubber to metal bond and the highest density of rubber coating. There re numerous bonding agents used to facilitate this bonding, depending upon what specific rubber is being bonded.

As used herein the term “rubber” refers to natural rubber and synthetic rubber.

As used herein the term “connected member” refers to a mechanical member that experiences vertical travel and is affixed to the ball joint assembly directly or with an adaptor bushing. It is located in the through bore of the ball.

The present invention relates to a novel design for a unitary, rubber isolating, spherical bearing ball joint for uses in horizontal applications that experience major vertical travel as well as minor side loads and angular loads. An example of such an application would be for the connection of the proximal end of a vehicle's radius arm (connected to the axle) to a mounting bracket on the frame. Here, while the majority of the motion experienced would be the vertical travel of the distal end of the radius arm, (as the a vehicle's axle moves up and down), there would also be some very limited side to side (horizontal) movement when the wheel ends of the axle are at different elevations, and some very limited angular (torsional) movement of the axle. The compression and elastic deformation of the rubber bushing handles all of the vertical, axial and horizontal loads, if they are not too large, however these are prone to failure and wear quickly.

A conventional ball joint allows for unhindered 360 degree rotational movement in applications with limited side to side movement. This 360 rotational motion need not be perpendicular to either face of the spherical bearing's race. It is made of a spherical ball sealed into a geometrically conforming spherical race. The ball has a central through bore for the frictional attachment of a rod member that attaches to a mechanical part that experiences complete or partial rotational movement about the linear axis of the rod (which passes through the midpoint of the ball). The ball is highly polished and may or may not have a bearing surface or coating (like Teflon) about its exterior, to reduce the friction the outer spherical surface of the ball experiences as it rotates within the ball race. The ball may rotate as well as swivel within the ball race.

The present invention has three embodiments disclosed herein, that can be utilized with plain housings or with housings having rod ends extending normally from them. The embodiments differ in their method of assembly although their overall operation remains the same. The first embodiment uses a pair of circular retaining clips/rings (circlips) to constrain the ball joint in its joint housing. The second embodiment uses a threaded lock plate, and the third embodiment uses a threaded lock plate with a replaceable split outer isolation sleeve. Any of these embodiments may be fabricated with threaded shank extending normally from the joint body or with a plain circular joint body adapted for insertion into another matingly conformed fitting. The three embodiments differ in the manner in which the joint housing is constrained within the joint body.

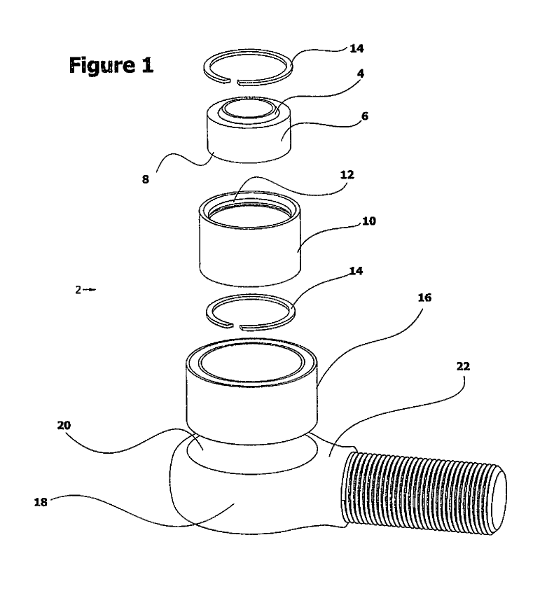

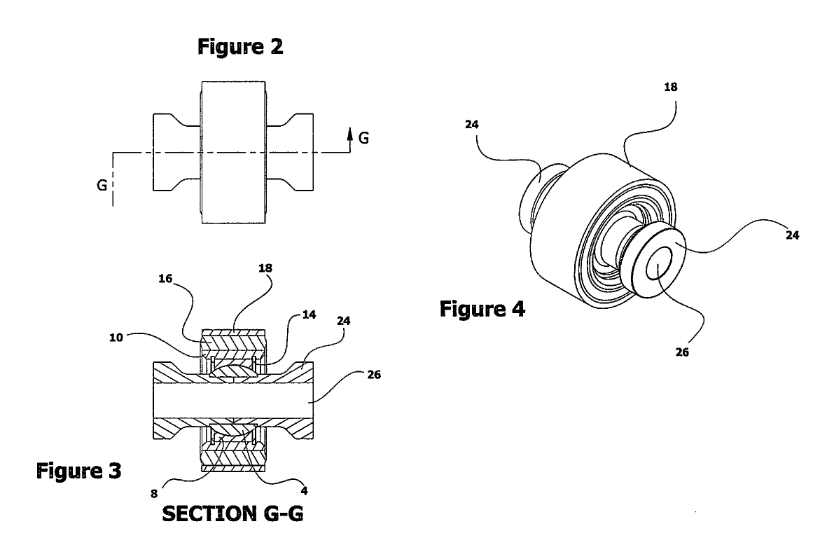

Looking at FIGS. 1-5 the first embodiment (simplest version) ball joint assembly 2 can be seen. A spherical ball 4 with a central through bore 6 is located into a socket of a right cylindrical race or cage 8 that is pressed under extreme pressure to matingly conform to the exterior of the ball 4, thereby sealing the ball into the center of the race 8. There may optionally be an inner friction-reducing layer such as Teflon′ placed between the ball and the inner wall of the race (not illustrated herein). These assemblies are commonly available and known as spherical bearings.

The cage and ball assembly is fitted into a right cylindrical joint housing 10 that is dimensionally sized to accept them. The thickness of the cage and ball assembly (the spherical bearing) is less than the thickness of the steel joint housing 8. The joint housing 8 has a cylindrical wall bounded by two ring ends 30 which define openings at either end. The outer face of the cylindrical wall has a roughened surface thereon, preferably accomplished by sandblasting or any other equivalent result yielding method. It has a dimension of length along its linear axis that exceeds the dimension of length of the race 8 taken along its linear axis. In this way, when the race is inserted and centrally located into the joint housing, there is a shoulder area remaining on the joint housing 10 beyond the extents of the two ends of the race 8. Adjacent each of the openings on the joint housing and on its shoulder areas are two, parallel circumferential grooves 12. These grooves have an inner diameter that is less than the outer diameter of the split rings 14. In this way, the split rings (or any functional equivalent such as a circular ring or circlip) is able to be compressed so as to be frictionally fitted into the grooves 12. The split rings 14 will then abut the ends of the race and hold the spherical bearing centered in the joint housing 10.

The steel joint body 18 is also an open ended circular cylinder (a right cylinder) where its inner wall has also been treated so as to have a roughened steel surface. However, its internal diameter is not sized for mating engagement with the outer diameter of the joint housing. Rather, the dimensional tolerance allows for a circular, cylindrical gap between the two bodies. The joint housing 10 is centered in the central void 20 of the joint body 18 and the remaining void between these bodies is filled with a rubber bushing 16 material that is then bonded to each of these steel components. This material may be a natural, or synthetic rubber or a functionally equivalent polymer. It must have elastic compression abilities. Such rubber to metal/steel bonding techniques and technology is well known in the industry and will not be developed further here. The isolation bushing 16 serves to flexibly and compressively connect the joint housing 10 to the joint body 18 which is one of the novel aspects of this device. Common thickness dimensions for this rubber, shock and vibration isolation bushing 16 would be in the 0.125 to 0.250 inch range, although this thickness can fall well outside these rough parameters, depending on the application.

FIG. 17 shows an alternate second embodiment ball joint 19 where the alternate joint body 19 is a cylindrical body for installation into a matingly dimensioned recess. It has no threaded shaft extending from its body so as to form a rod arm.

One of the advantages of this design, is that the joint body and joint housing are but one unit affixed as a unitary, non separable component by the rubber bonded between the joint body and the joint housing. Thus there is no possibility of wrong ordering or of the mismatching components when assembling or replacing parts. Only the spherical bearing ever need be removed for replacement.

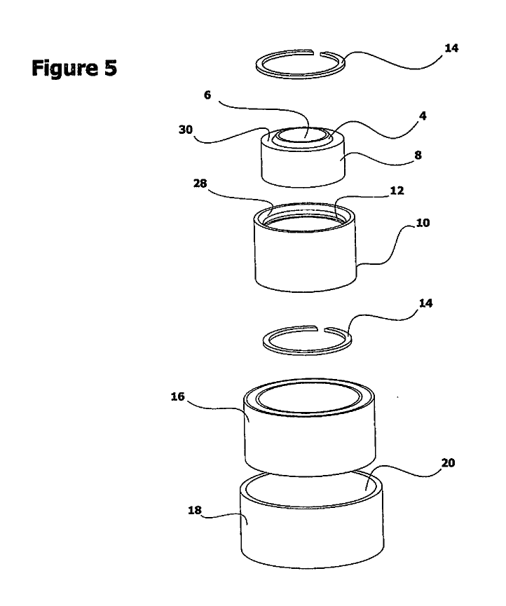

As illustrated in FIGS. 1 and 5, the joint body 18 may or may not have a threaded stud 22 extending normally therefrom. In the through bore 6 of the ball 4 a cylindrical bushing member may be directly located, or any style of bushing member having its own bore dimensions 26 may be operationally inserted. FIG. 4 shows a two piece split flanged bushing member 24 frictionally pressed into the through bore 6 of the ball 4.

It is to be noted that the ball 4 extends out past the ring ends 30 of the race 6. In this way there the ball is not limited to just rotational movement, rather it can handle limited off axis rotation such as a “wobble” or rotation that is not aligned with the linear axis of the spherical bearing.

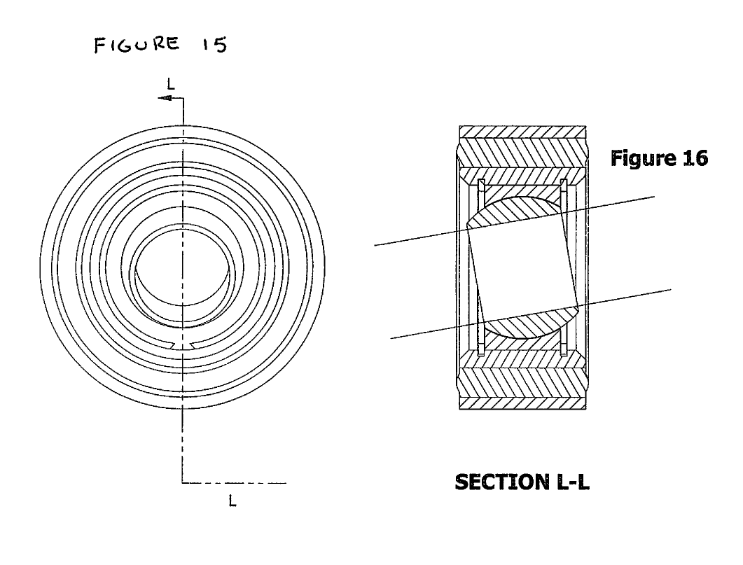

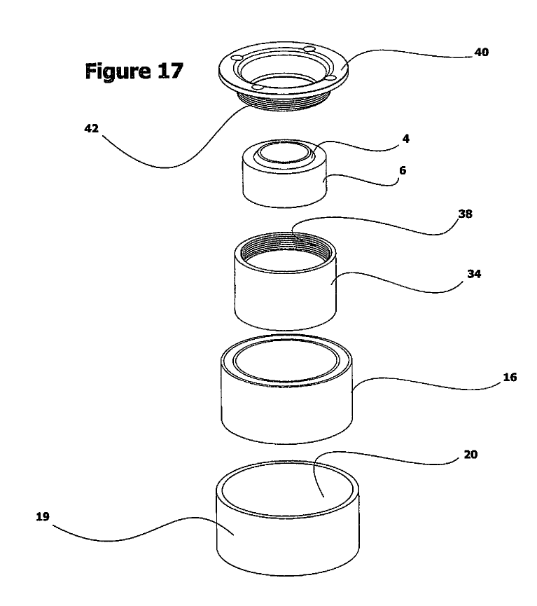

In a similar manner, it is to be noted that the shoulder 28 of the joint housing 10 (also in the joint housing of all the embodiments) is tapered or stepped and does not extend beyond either end of the spherical bearing's race 6 far enough to contact a line (the normal angular extents line 70) extending along the side wall of the through bore 6 of the ball 4 at the point where the ball 4 is rotated in the race 6 such that the line contacts the inner extent of the ring ends 30 of the race 6. (This point represents the limit of the angular rotation extent of the ball 4 in the race 6 as shown in FIGS. 15 and 16.) This is a common feature of all embodiments.

It is also to be noted that under shock loads, the connected member may transmit forces that compress the isolation bushing slightly so as to slightly tilt the joint housing 10 in the joint body 18 thereby increasing the angle that this normal angular extents line has with respect to the joint body 18. Without this extra cushioning effect, it would be possible for the connected member (or any cylindrical busing member) to strike the end of the joint housing. Thus, the isolation bushing (intended for vibrational isolation and to prolonged life) has the unexpected result of preventing damage to the connected bodies and the spherical bearing under excess rotation and excess rotation while experiencing a vertical, horizontal or angular shock load.

The advantages of this novel design are numerous. First, the rotational and angular motions of a connected member to the ball joint assembly (any embodiment) are handled with a minimal of friction by the rotating ball 4 in the ball race 6 (eliminating the wear experienced by the prior art rubber bushings). Second, the ball and race can handle torque spikes (which caused tears in the prior art bushings). Third, the isolation bushing 16 acts as a vibrational damper. Fourth, the ball 4 handles axial movement (which also caused tears in the prior art bushings). Fifth the ability of the isolation bushing 16 to elastically deform allows for axial loads to be handled even when the ball 4 has reached its point of maximum axial rotation within the race 6, giving a margin of safety before damage to the ball 4 and race 6. Sixth, the isolation bushing elastically compresses to accommodate horizontal loads and horizontal shock loads preventing damage to the ball 4 and race 6 (these cause the inelastic deformation and breakdown of the prior art bushings). Lastly, in certain embodiments the isolation 16 bushing may be replaced upon wear, greatly extending the life of the joint in severe side and vertical load applications.

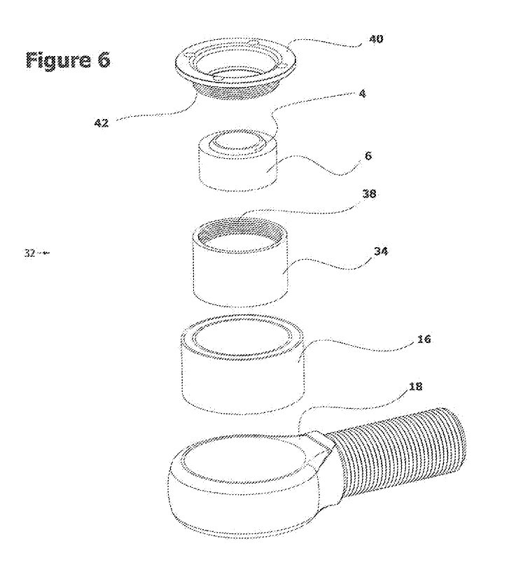

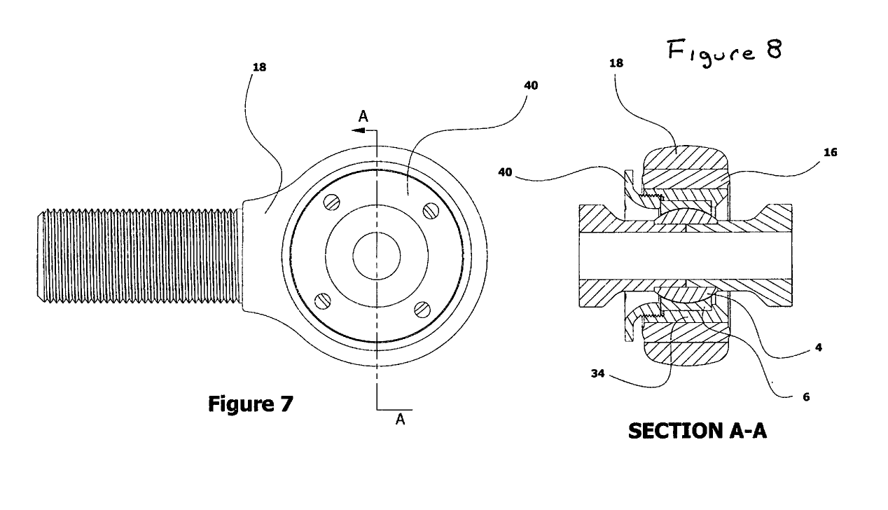

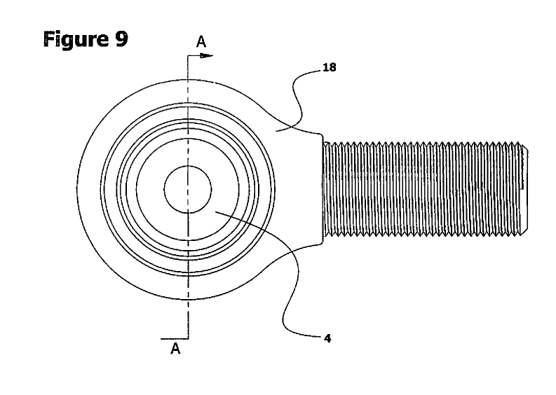

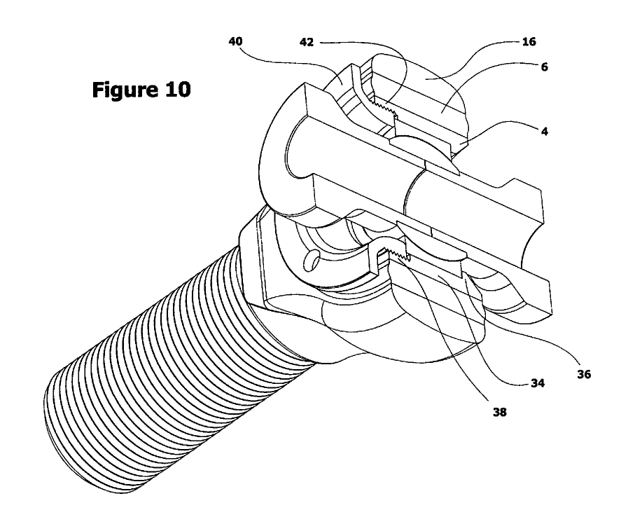

Looking now to FIGS. 6-10, the second embodiment spherical ball joint assembly 32 can best be seen. The second embodiment eliminates the split rings of the first embodiment spherical ball joint 2 and uses a circular lock plate 40 (threaded or friction fit) to constrain the spherical bearing, thus adding the ability to minimize any side-to-side play of the race 8 in the joint housing 10. The lock plate 40 is a circular ring with a raised flange thereon (that may or may not have external threads on the raised flange.) The spherical bearing is identical to that of the first embodiment (comprised of the ball 4 and race 6) as is the joint body 18 and the isolation bushing 16. The second joint housing 34 is dimensionally sized to internally accept the spherical bearing. At its distal end it has a raised lip 36 and at its proximal end it has a circular dado 38. The dado 38 may be sized for frictional engagement by a pressed fit with the lock plate 40 or it may be internally threaded about its outer wall 42 for engagement into a set of external threads cut into the circular dado 38. Again, like the first embodiment, the outer face of the cylindrical wall of the second joint housing 34 and the inner face of the joint body 18 have roughened surfaces thereon for the rubber to metal bonding of the isolation bushing 16 between them as disclosed earlier. This holds the joint housing and the joint body in a vibrationally dampened configuration. The circular ring section of the lock plate 40 has a series of orifices therein for the insertion of an installation tool that allows for the rotation of the lock plate into the joint housing.

The advantages of this second embodiment 32 is that the lock plate 40 can be pressed or threaded further into the depth of the joint housing 34 to abut the sides of the race 6 of the spherical bearing preventing any side-to-side play that is inherent with the split ring retention design of the joint housing 34 in the first embodiment.

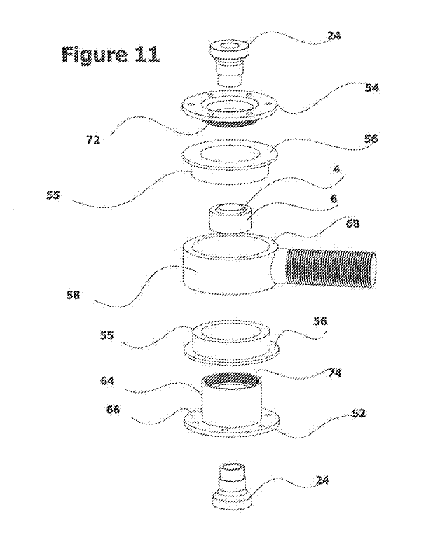

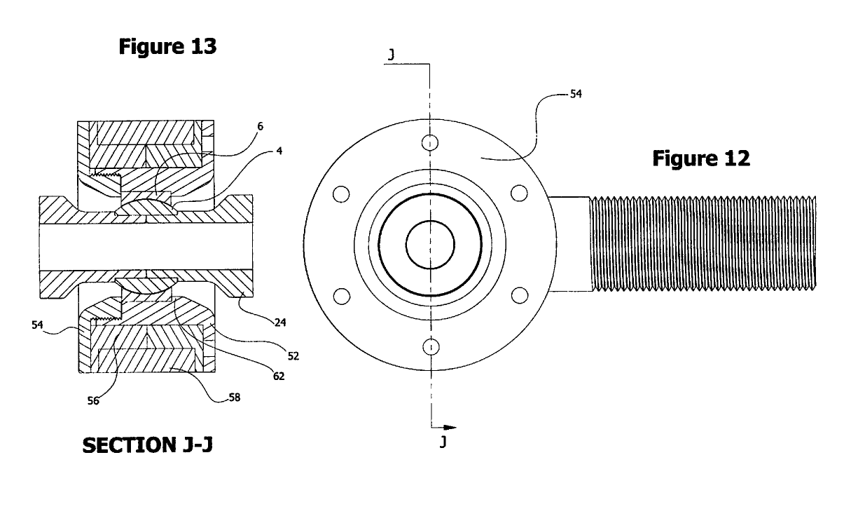

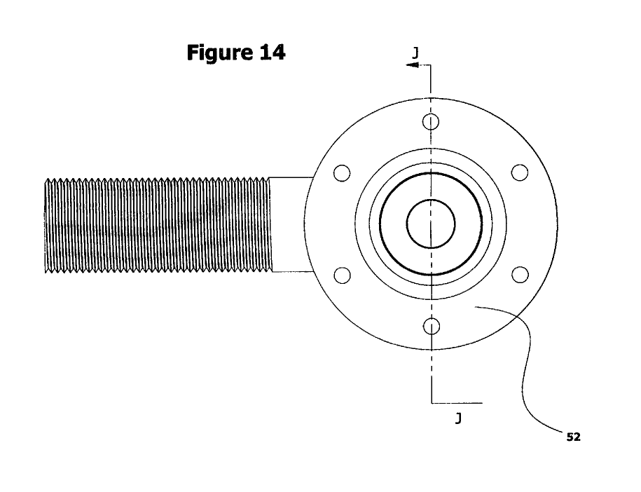

Looking at FIGS. 11-14 it can be seen that the third embodiment 50 uses a two part third joint housing (the joint sleeve assembly) with a replaceable rubber or polymer split vibrational isolation sleeve. This embodiment is intended for more severe applications in which the assembly would be subject to harder or longer wear, and where replacement of the vibration isolation sleeve would prevent replacement of the entire assembly.

It differs from the second embodiment as it uses a two part joint sleeve assembly 52 and 54, and the isolation sleeve is made of a pair of abutting identical split polymer or rubber isolation rings 55. The isolation rings are rubber right cylinders with raised flanges extending normally (at 90 degrees) from one of each of their ends.

The joint sleeve assembly 52 and 54 is made of a first cylindrical ring 52 and a second cylindrical ring 54 that threadingly engage. The rings have different depth cylindrical bodies yet have identical raised flanges extending from one of each of their ends. The first cylindrical ring 52 is identical to the lock plate of the second embodiment and the second cylindrical ring 54 differs from the first cylindrical ring 52 only by the length of its cylinder and the location of its threads. The first cylindrical ring 52 has a set of threads formed on the external face of its cylindrical body and the second cylindrical ring 54 has a set of threads formed on the internal face of its cylindrical wall. It is the threaded engagement of these two cylindrical rings 52 and 54 that cause the joint sleeve assembly to draw together towards the midpoint of the ball joint therein sandwiching the isolation rings 55 into place.

When assembled, the circular rubber cylinders of said isolation rings are frictionally engaged between the outer face of the second cylindrical ring and an inner face of the joint body, and the raised flange of the first isolation ring is frictionally engaged between an inner face of the raised flange of the first cylindrical ring and a first side of the modified joint body; and the raised flange of the second isolation ring is frictionally engaged between the inner face of the raised flange of the second cylindrical ring and a second side of the modified joint body.

Since the isolation rings 55 are meant for replacement and are not bonded between the joint sleeve and the joint body, the two isolation rings 55 must be maintained in their position and not allowed to slide out from between the joint body and the joint sleeve assembly. Thus, another reason for the raised flanges on the first and second cylindrical rings, and the isolating flange on the split bushing. Each of the raised flanges on the first and second cylindrical rings have a series of orifices therein for the insertion of assembly tools that will be rotated simultaneously to install the joint sleeve assembly under and aside the split bushing.

Here, the modified joint body 58 is narrower than in the previous embodiments. This is to accommodate the thickness of the raised flanges 56 on the split isolation rings 55 between the assembled joint sleeve assembly 52 and 54 and the joint body 58. This offers an additional degree of side-to-side lateral shock absorption. These flanges 56 act as vibrational dampeners and to absorb any horizontal shock loads experienced and transmitted by the connected member. Unlike the like the first and second embodiments, the outer face of the cylindrical wall of the joint sleeve assembly and the inner face of the third, modified joint body 58 do not have roughened surfaces thereon as there is no rubber to metal bonding of the rubber isolation rings 55 between these parts as in the first and second embodiments.

As can be seen, the assembly of the third embodiment spherical ball joint 50 differs considerably for that of the other two embodiments. The spherical bearing is dimensionally sized for frictional engagement within the cylindrical recess of first half cylindrical ring 52. Once placed or pressed inside, the spherical bearing will slide down the depth of the first cylindrical ring 52 until its race 6 abuts the inner shoulder 62. Then one of the identical isolation rings 55 will be slid over the outer cylindrical face 64 of the first cylindrical ring 52 until its raised flange 56 contacts the inner face of first outer flange 66. This assembly will then be placed or pressed into the modified joint body 58 until the flange 56 of the isolation ring 55 contacts one of the edge faces 68 of the modified joint body 58. The other isolation ring 55 is then slid over and along the outer cylindrical face 64 of the second cylindrical ring 54 and slid into the modified joint body 58 until its raised flange 56 contacts the other edge face 68 of the modified joint body. At this time the two identical isolation rings will have their inner edges in contact with each other. This interface will reside along the longitudinal centerline of the ball joint. The second half joint sleeve 54 will have its external threads 72 operationally engaged with the matingly conforming internal threads 74 of the first half joint sleeve 52 and tightened down by insertion of a rotational tool into a series of orifices formed in both of the joint sleeves, so as to achieve compression of the raised flanges 55 between the joint sleeve and the faces 68 on the modified joint body 58. This act of tightening will also constrain the spherical bearing from side to side movement. The device is now ready for the pressed installation of the two halves of the bushing 24. Notably, the joint body 58 is narrower than the twice the thickness of the isolation rings minus twice the thickness of the raised flanges 55. The isolation rings

Simply stated, this improved spherical ball joint assembly is a vast improvement over the prior art because it is available as a unitary piece rather than a conglomeration of ill fitting mechanical components and mostly because it remains together and operational under combined vertical, angular, horizontal and torsional loads as well as providing vibrational isolation.

While certain features and aspects have been described with respect to exemplary embodiments, one skilled in the art will recognize that numerous modifications are possible. In the way of an exemplary, threaded engagements may be replaced by pressed, welded or glued fittings. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A ball joint assembly comprising:
a spherical ball with a central cylindrical bore formed therethrough;
a right cylindrical race rotationally constraining said ball, said race having two race ends;
a cylindrical joint housing, said joint housing sized for frictional engagement with said cylindrical race;
a joint body having an open ended cylindrical body; and
a rubber isolation bushing residing between said joint housing and said joint body.

2. The ball joint assembly of claim 1 wherein said joint housing has a first open end and a second open end.

3. The ball joint of claim 1 wherein said joint housing has a roughened steel outer surface and said joint body has a roughened steel inner surface and said rubber bushing is bonded to said steel surfaces.

4. The ball joint of claim 2 further comprising a pair of circular, retaining split rings, wherein said joint housing has a pair of shoulder areas that extend beyond said race ends, each said shoulder area having a circumferential groove formed therein adjacent said race ends for the placement of said split rings.

5. The ball joint of claim 3 wherein said joint body has a threaded rod affixed thereto.

6. The ball joint of claim 1 further comprising a circular lock plate, said lock plate engageable in said joint housing adjacent one of said race ends.

7. The ball joint of claim 6 wherein said lock plate is a circular disk with an inner raised flange extending therefrom, said flange having a set of external threads formed thereon, and wherein said joint housing has a distal end and a proximal end, said distal end having a raised lip and its proximal end having a circular dado with a set of internal threads sized for mating engagement with said external threads on said lock plate, so as to constrain said race between said raised flange and said raised lip.

8. The ball joint of claim 7 wherein said joint housing has a roughened steel outer surface and said joint body has a roughened steel inner surface and said rubber bushing is bonded to said steel surfaces.

9. The ball joint of claim 1 wherein said joint housing is a two part joint sleeve assembly and said rubber isolation bushing is made of two abutting rubber isolation rings.

10. The ball joint of claim 9 wherein both of said two isolation rings are identical and are each replaceable circular rubber cylinders with a raised isolating flange extending normally outward from an end thereof.

11. The ball joint of claim 10 wherein said joint sleeve assembly is made of a first cylindrical ring and a second cylindrical ring that threadingly engage beneath said isolation rings so as to trap said isolation rings between said joint body and said joint sleeve assembly.

12. The ball joint of claim 11 wherein said first and second cylindrical rings have different depth cylindrical bodies yet have identical raised flanges extending from one of each of their ends; and wherein said first cylindrical ring has a first set of threads formed on an external face of its cylindrical body and said second cylindrical ring has a mating, second set of threads formed on an internal face of its cylindrical wall.

13. The ball joint of claim 12 wherein said circular rubber cylinders of said isolation rings are frictionally engaged between an outer face of said second cylindrical ring and an inner face of said joint body; and said raised flange of said first isolation ring is frictionally engaged between an inner face of said raised flange of said first cylindrical ring and a first side of said joint body; and said raised flange of said second isolation ring is frictionally engaged between an inner face of said raised flange of said second cylindrical ring and a second side of said joint body.
